(19) United States
(12) Patent Application Publication
(10) Pub. No.: US 2024/0364087 A1
(43) Pub. Date: Oct. 31, 2024

(54) ADJUSTABLE DEPTH ELECTRICAL BOX

(71) Applicant: GENESEE A&B, LLC, Portland, TN (US)

(72) Inventors: Alexander Walter Sherrill, Castalian Springs, TN (US); Todd Elliott Gerlach, Hendersonville, TN (US)

(21) Appl. No.: 18/647,609

(22) Filed: Apr. 26, 2024

Related U.S. Application Data
(60) Provisional application No. 63/498,288, filed on Apr. 26, 2023.

(51) Int. Cl. H02G 3/12; H02G 3/08

(52) U.S. Cl. CPC H02G 3/126; H02G 3/081

(57) ABSTRACT

An adjustable depth electrical box includes a bracket that includes a first interlocking structure and a first retention feature. An electrical box is slidably supported on the bracket and includes a second interlocking structure that is configured to slide relative to the first interlocking structure between multiple discrete positions. The electrical box has a second retention feature that cooperates with the first retention feature. The first and second interlocking structures are configured to interlock with one another in one of the multiple discrete positions and resist a sliding force above a threshold thereby providing a discrete installation depth. The first and second retention features are configured to permit uninhibited sliding of the first and second interlocking structures between first and second stops but prevent overtravel of the bracket relative to the electrical box.

### CROSS-REFERENCE TO RELATED APPLICATION

This disclosure claims priority to U.S. Provisional Patent Application No. 63/498,288 filed Apr. 26, 2023.

### BACKGROUND

This disclosure relates to adjustable depth electrical boxes used for residential or commercial electrical installations of switches and outlets, for example.

There are various electrical codes that relate to the setback of electrical boxes from a finished surface, such as drywall or other materials. Because the code and the setback requirement differ based upon the applications, it is desirable to have an inventory of different boxes providing different setbacks. But, maintaining a inventory of boxes is cumbersome and can result in costly delays if the correct setback box is not available.

Current solutions include a plastic electrical box supported by a metallic bracket. The electrical box is slidable in a longitudinal direction in response to turning a longitudinally extending screw. While effective, this solution is costly.

### SUMMARY

In one exemplary embodiment, an adjustable depth electrical box includes a bracket that includes a first interlocking structure and a first retention feature, an electrical box that is slidably supported on the bracket and includes a second interlocking structure that is configured to slide relative to the first interlocking structure between multiple discrete positions, the electrical box has a second retention feature that cooperates with the first retention feature. The first and second interlocking structures are configured to interlock with one another in one of the multiple discrete positions and resist a sliding force above a threshold thereby providing a discrete installation depth, and the first and second retention features are configured to permit uninhibited sliding of the first and second interlocking structures between first and second stops but prevent overtravel of the bracket relative to the electrical box.

In a further embodiment of any of the above, one of the first and second interlocking structures includes at least one slot, and the other of the first and second interlocking structures includes at least one tab that is received in one of the slots corresponding in the discrete installation depth.

In a further embodiment of any of the above, the at least one slot is provided on the electrical box, and the at least one tab is provided on the bracket.

In a further embodiment of any of the above, the at least one slot includes multiple slots.

In a further embodiment of any of the above, the at least one tab includes multiple tabs.

In a further embodiment of any of the above, the at least one slot includes multiple slots.

In a further embodiment of any of the above, the at least one slot is provided in a wall and extends through an entire thickness of the wall.

In a further embodiment of any of the above, the at least one slot is provided on the bracket, and the at least one tab is provided on the electrical box.

In a further embodiment of any of the above, one of the first and second retention features is provided by a longitudinal pocket that provides the first and second stops at opposing ends of the pocket, and the other of the first and second retention features is provided by a retainer that is received in the pocket and configured to provide at least one of the first and second stops.

In a further embodiment of any of the above, the bracket is a stamped sheet metal structure, and the electrical box is plastic.

In a further embodiment of any of the above, the first retention feature is unitarily and integrally with the bracket.

In a further embodiment of any of the above, the retainers are stamped from and extend proud of an adjacent surface of the bracket.

In a further embodiment of any of the above, the second retention feature is unitarily and integrally with the electrical box.

In a further embodiment of any of the above, the pocket is provided in the electrical box, and a pair of opposing retainers are provided on the bracket. One of the opposing retainers is configured to abut the first stop at one adjustment limit, and the other of the opposing retainers is configured to abut the second stop at another adjustment limit.

In a further embodiment of any of the above, the bracket includes at least one reinforcing rib.

In a further embodiment of any of the above, the bracket includes opposing hooks that are received in corresponding grooves in the electrical box. The hooks and grooves define an adjustment plane.

### BRIEF DESCRIPTION OF THE DRAWINGS

The disclosure can be further understood by reference to the following detailed description when considered in connection with the accompanying drawings wherein:

FIG. 1 is a prior art adjustable electrical box having a threaded fastener for adjusting the installation depth.

FIGS. 2A and 2B are respectively front and side view of an adjustable electrical box secured to a stud wall.

FIG. 3 is a perspective view of a modified prior art electrical box that can be used with the disclosed adjustable depth electrical box.

FIGS. 4A and 4B are first and second perspective views of one example bracket for use with the disclosed adjustable depth electrical box.

FIG. 5 illustrates the electrical box of FIG. 3 mounted to the bracket shown in FIGS. 4A and 4B.

FIGS. 6A and 6B are cross-sectional views through the adjustable depth electrical box shown in FIG. 5 and respectively taken along lines 6A-6A and 6B-6B.

FIG. 7 is a perspective view similar to the electrical box shown in FIG. 3.

FIGS. 8A and 8B are first and second perspective views of another example bracket for use with the disclosed adjustable depth electrical box of FIG. 3, 7 or 9.

FIG. 9 is a perspective view of another example electrical box.

FIG. 10 is a perspective view of another example bracket for use with the disclosed adjustable depth electrical box shown in FIG. 9.

FIG. 11 is a perspective view of yet another example electrical box.

FIG. 12 is a perspective view of yet another example bracket for use with the disclosed adjustable depth electrical box shown in FIG. 11.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

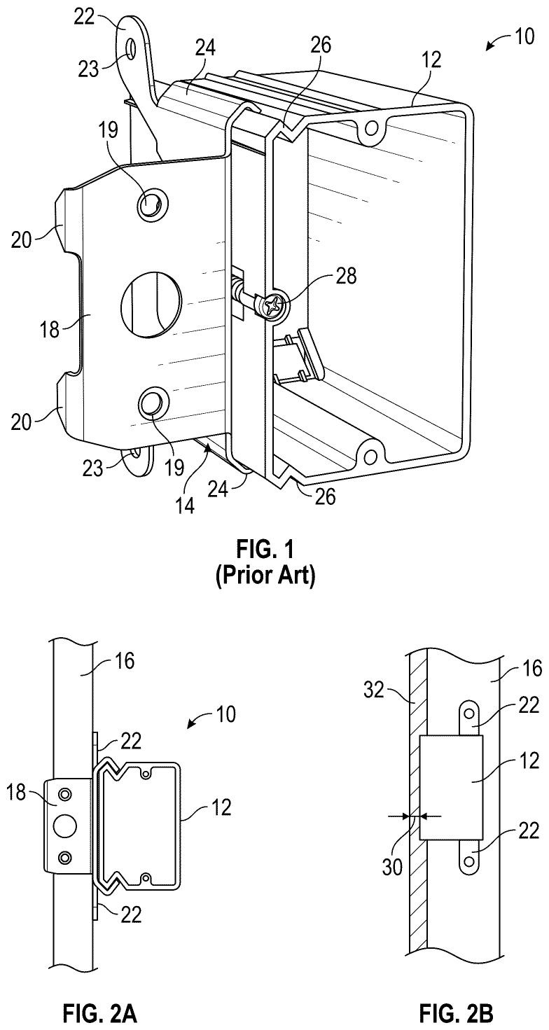

One type of common adjustable depth electrical box 10 is shown in FIG. 1. This type of installation box includes an electrical box 12 slidably supported on a bracket 14. The bracket 14 is mounted to a stud 16 as shown in FIGS. 2A and 2B when installed.

One type of bracket includes a front flange 18 having locating legs 20 and holes 19 that can be used to locate and secure the bracket 14 to the front face of the stud 16. The bracket 14 may additionally or alternatively include side flanges 22 having holes 23 for securing the bracket 14 to the side of the stud 16, if desired.

For position adjustment of the electrical box 12, the bracket 14 has spaced apart hooks 14 received in complimentarily shaped spaced apart grooves 26 provided on the electrical box 12. A fastener 28 includes a head that is trapped within an opening or notch in the electrical box 12 to axially retain the fastener 28 with respect to the electrical box 12 while permitting rotation. The threaded end of the fastener 28 is received in a correspondingly threaded hole in the bracket 14 (not shown). Clockwise and counterclockwise rotation of the fastener 28 slidingly moves the electrical box 12 in and out with respect to the bracket 14 to achieve the desired setback 30 relative to the finished material 32, such as drywall (see, FIG. 2B). The hook/groove interface 24/26 permits the electrical box 12 to freely slide in an adjustment plane as the fastener 28 is being turned without the electrical box 12 racking with respect to the bracket 14. This fastener 28 and the adjustment arrangement generally is rather complex, making this type of adjustable depth electrical box rather expensive.

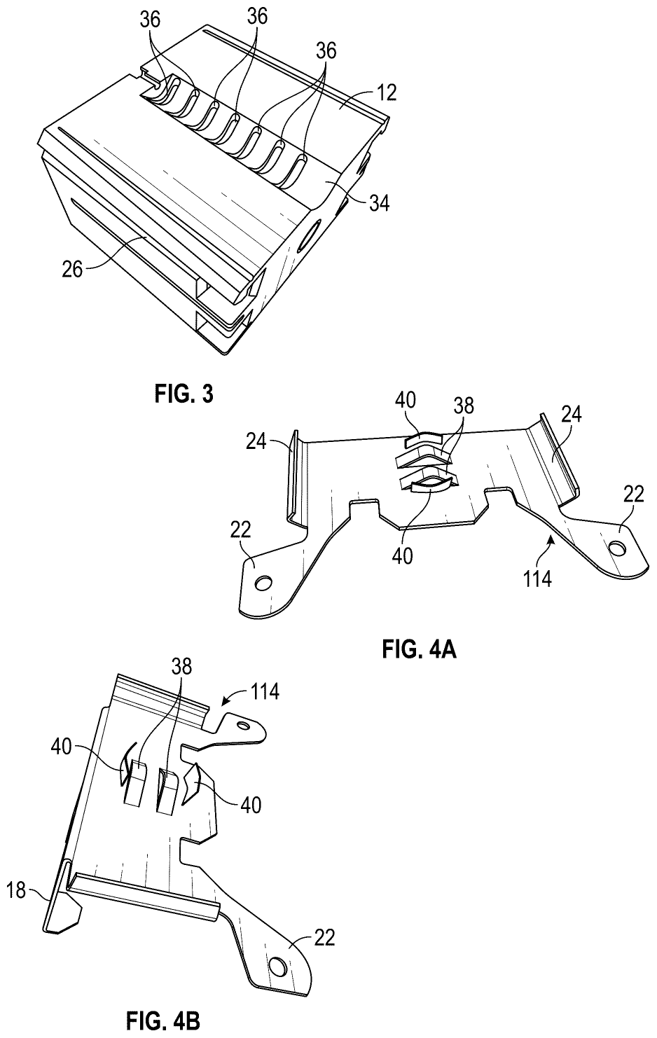

Example simplified adjustable depth electrical boxes are shown in FIGS. 3-12, which eliminate the need for the expensive fastener arrangement. Generally, the bracket 14 includes a first interlocking structure, and the electrical box 12 is slidably supported on the bracket 14 and includes a second interlocking structure configured to slide relative to the first interlocking structure between multiple discrete positions. Since there is no threaded fastener to maintain the bracket and electrical box in the desired position, the first and second interlocking structures (e.g., slots and tabs) are configured to interlock with one another in one of the multiple discrete positions in response to the installer pushing/pulling on the electrical box. The first and second interlocking structures resist a sliding force above a threshold thereby providing the desired discrete installation depth.

The bracket 14 also includes a first retention feature, and the electrical box 12 has a second retention feature that cooperates with the first retention feature. Again, since there is no fastener, the first and second retention features are permit uninhibited sliding of the first and second interlocking structures but provide stops that prevent overtravel of the bracket 14 relative to the electrical box 12 so they cannot be inadvertently separated from one another when adjusting the depth.

In the disclosed example adjustable depth electrical boxes, the hooks 24 and grooves 26 may be used the define a sliding adjustment plane.

One example adjustable depth electrical box is shown in FIGS. 3-6B, If desired, the same or similar electrical box 12 may be used as shown in FIG. 1, but with the addition of an array of longitudinally spaced apart slots 36, as best shown in FIG. 3. Referring to FIGS. 4A-4B, a bracket 114 includes spaced apart triangular protrusions 38 that are slidably received within a correspondingly shaped channel 34 in the electrical box 12. In one example, the bracket 114 is constructed from stamped sheet metal, and the electrical box 12 is constructed from an injection molded plastic. The slots 36 are provided in the channel 34 and extend entirely through the wall thickness of the electrical box 12 in the example shown. It should be understood that the slots 36 can instead be provided as pockets in the sidewall of the electrical box 12, but this would add cost and complexity. The channel 34 extends longitudinally in a sliding adjustment plane along which the electrical box 12 can be moved relative to the bracket 114. In the example shown, the protrusions 38 have a width that is greater than a width of the slots 36 so that the protrusions 38 do not become undesirably trapped within the slots 36 when sliding the electrical box 12 relative to the bracket 114. These protrusions 38 provide additional stability to the hook/groove interface 24/26 during sliding, and may be omitted if desired.

Spaced apart flexible plastic tabs 40 are provided on the bracket 114. Two tabs 40 are shown, however, fewer or more tabs may be provided. In the example, the tabs 40 may be provided by opposing ends of a U-shaped structure that is adhered to the bracket 114 beneath an underside of the protrusions 38, or otherwise secured to the bracket 114. The ends of the tabs 40 may be bent in a V-shape, U-shape or other non-flat shape, or structurally reinforced if desired to provide further rigidity so that once the tab 40 is received in its respective slot 36, the relative position of the electrical box 12 and bracket 114 will be maintained during subsequent electrical component installation and use. In the example, the shape of the tabs 40 are oriented in opposite directions (e.g., the U-shapes face one another in this example) so that the force required to slide the electrical box 12 is approximately the same in either direction along the adjustment plane.

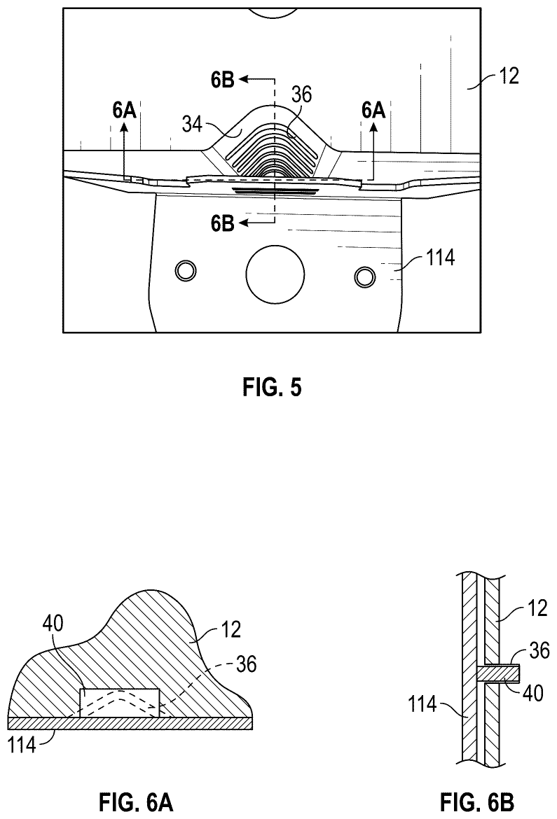

Referring to FIGS. 5-6B, in operation the electrical box 12 may be pushed and pulled with respect to the bracket 114 to slide the electrical box 12 to the position corresponding to the desired installation depth or setback for the particular finished material. Sliding the electrical box seats the flexible tabs 40 within a corresponding slot 36. The tabs 40 are designed to sufficiently flex so as to be responsive to the pushing and pulling of the electrical box 12 without breaking while also providing sufficient structural rigidity to hold the electrical box 12 in the desired position once achieved.

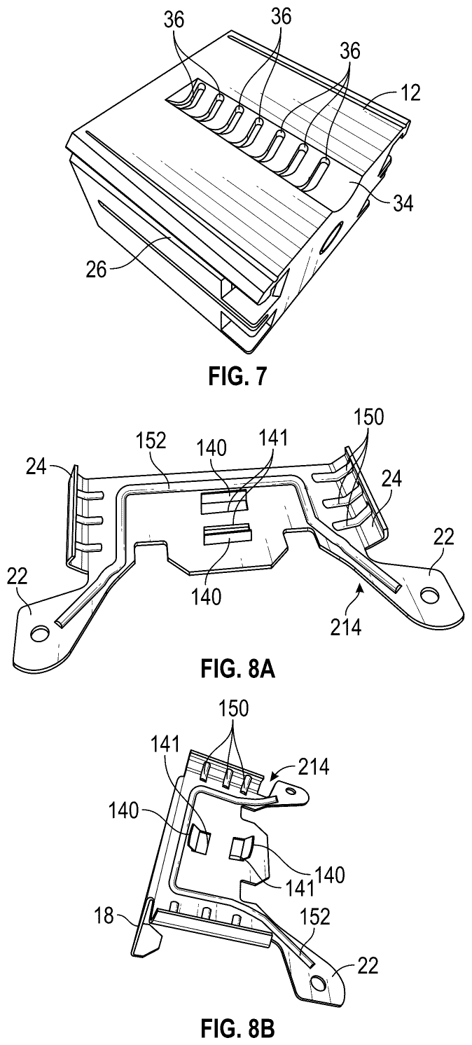

Another example adjustable depth electrical box is shown in FIGS. 7-8B. the electrical box 12 is similar to the one shown in FIG. 3. In the example bracket 214 shown in FIGS. 8A and 8B, stamped reinforcing ribs 150, 152 are provided to increase stiffness so the electrical box 12 will not come off the bracket 214 under downward loads on the electrical box 12 mandated by regulatory codes while enabling a thinner, cheaper bracket.

The tabs 140 unitarily and integrally formed with the bracket 214 by piercing the bracket 214, which results in a corresponding hole 141. If a thicker bracket were to be used, there may not be sufficient flex in the tabs 140 to permit adjustment. Thus, the ribs 150 and/or 152 may be particularly desirable in this configuration.

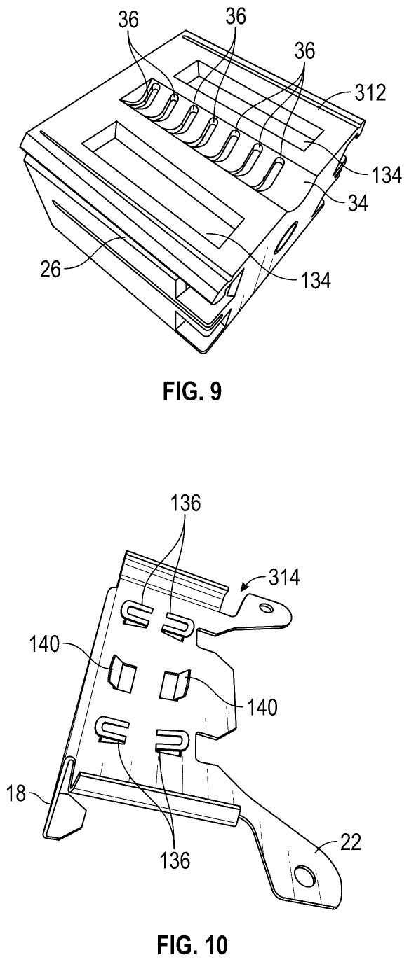

In another example shown in FIGS. 9 and 10, one of the first and second retention features is provided by a longitudinal pocket 134 providing the first and second stops at opposing ends of the pocket 134. In the example, a pocket 134 is provided on either side of the longitudinal array of slots 36. The other of the first and second retention features is provided by one or more retainers 136, on the bracket 314 in the example shown. At least one retainer 136 is received in its respective pocket 134.

As shown in FIG. 10, the retainers 136 are unitarily and integrally with the bracket 314, for example by piercing, such that the retainers 136 are stamped from and extend proud of an adjacent surface of the bracket 314. The retainers 136 are pushed flat to assemble the bracket 314 onto the electrical box 312, then springing back outward once received in its pocket 134. Once assembled, one of the opposing retainers 136 is configured to abut the first stop (one longitudinal end of the pocket 134) at one adjustment limit, and the other of the opposing retainers 136 is configured to abut the second stop (other longitudinal end of the pocket 134) at another adjustment limit. This arrangement prevents the electrical box 312 from being pushed or pulled off the bracket 314 while adjusting the depth.

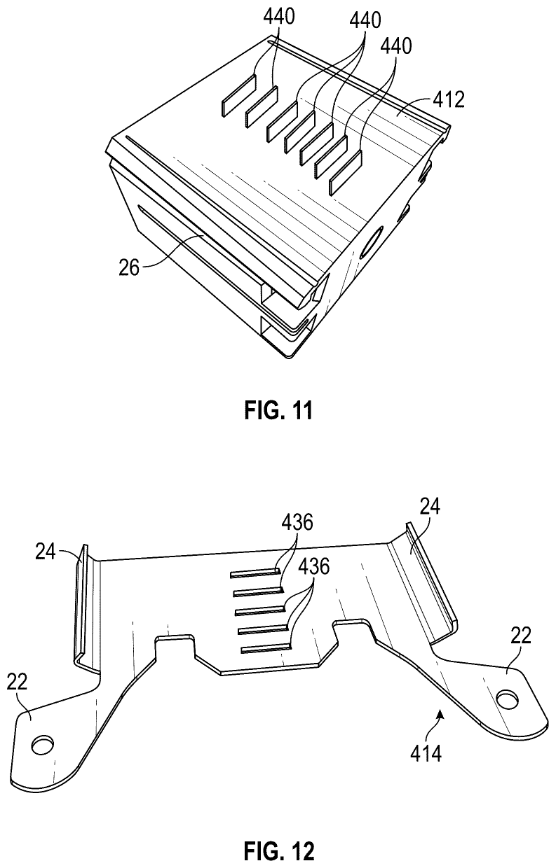

With the example adjustable depth electrical box shown in FIGS. 11 and 12, the slots 436 are pierce into the bracket 414 and the tabs 440 are provided by the electrical box 412 (integrally or separately formed and secured).

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. An adjustable depth electrical box comprising:
a bracket including a first interlocking structure and a first retention feature;
an electrical box slidably supported on the bracket and including a second interlocking structure configured to slide relative to the first interlocking structure between multiple discrete positions, the electrical box having a second retention feature cooperating with the first retention feature;
wherein the first and second interlocking structures are configured to interlock with one another in one of the multiple discrete positions and resist a sliding force above a threshold thereby providing a discrete installation depth; and
wherein the first and second retention features are configured to permit uninhibited sliding of the first and second interlocking structures between first and second stops but prevent overtravel of the bracket relative to the electrical box.

2. The adjustable depth electrical box of claim 1, wherein one of the first and second interlocking structures includes at least one slot, and the other of the first and second interlocking structures includes at least one tab received in one of the slots corresponding in the discrete installation depth.

3. The adjustable depth electrical box of claim 2, wherein the at least one slot is provided on the electrical box, and the at least one tab is provided on the bracket.

4. The adjustable depth electrical box of claim 2, wherein the at least one slot included multiple slots.

5. The adjustable depth electrical box of claim 2, wherein the at least one tab includes multiple tabs.

6. The adjustable depth electrical box of claim 5, wherein the at least one slot included multiple slots.

7. The adjustable depth electrical box of claim 2, wherein the at least one slot is provided in a wall and extends through an entire thickness of the wall.

8. The adjustable depth electrical box of claim 2, wherein the at least one slot is provided on the bracket, and the at least one tab is provided on the electrical box.

9. The adjustable depth electrical box of claim 1, wherein one of the first and second retention features is provided by a longitudinal pocket providing the first and second stops at opposing ends of the pocket, and the other of the first and second retention features is provided by a retainer received in the pocket and configured to provided at least one of the first and second stops.

10. The adjustable depth electrical box of claim 9, wherein the bracket is a stamped sheet metal structure, and the electrical box is plastic.

11. The adjustable depth electrical box of claim 10, wherein the first retention feature is unitarily and integrally with the bracket.

12. The adjustable depth electrical box of claim 11, wherein the retainers are stamped from and extend proud of an adjacent surface of the bracket.

13. The adjustable depth electrical box of claim 12, wherein the second retention feature is unitarily and integrally with the electrical box.

14. The adjustable depth electrical box of claim 9, wherein the pocket is provided in the electrical box, and a pair of opposing retainers are provided on the bracket, one of the opposing retainers configured to abut the first stop at one adjustment limit, and the other of the opposing retainers configured to abut the second stop at another adjustment limit.

15. The adjustable depth electrical box of claim 10, wherein the bracket includes at least one reinforcing rib.

16. The adjustable depth electrical box of claim 1, wherein the bracket includes opposing hooks that are received in corresponding grooves in the electrical box, the hooks and grooves defining an adjustment plane.
